(19) United States
(12) Patent Application Publication
(10) Pub. No.: US 2025/0237249 A1
(43) Pub. Date: Jul. 24, 2025

(54) CONNECTOR ASSEMBLY

(71) Applicant: NORTH AMERICA ELEVATE HEALTHCARE HUMAN CAPITAL INC., Saint-Laurent (CA)

(72) Inventors: Dominic TREMBLAY-GAGNON; Philippe JEAN

(73) Assignee: NORTH AMERICA ELEVATE HEALTHCARE HUMAN CAPITAL INC., Saint-Laurent (CA)

(21) Appl. No.: 19/028,866

(22) Filed: Jan. 17, 2025

Related U.S. Application Data
(60) Provisional application No. 63/622,748, filed on Jan. 19, 2024.

(51) Int. Cl. F16B 7/20; F16L 37/248; G09B 23/34; H01R 13/00

(52) U.S. Cl. CPC F16B 7/20; F16L 37/248; H01R 13/005; G09B 23/34; H01R 2201/18

(57) ABSTRACT

There is provided a connector assembly comprising: a first connector comprising: a main body; a first hollow body having an inner face, the first body being rotatably mounted to the main body and comprising a connection protrusion projecting inwardly from the inner face; and a biasing body mounted to the main body and the first body for applying a biasing rotational force on the first body in a first rotational direction; and a second connector comprising a second hollow body provided with a recess configured for receiving the connection protrusion therein, the second body comprising an engaging protrusion projecting within the recess. The second connector being configure such that when the connection protrusion is pushed against the second body, the first body is rotated in a second rotational direction until the connection protrusion is positioned into the retaining slot, thereby removably securing the first and second connector together.

### CROSS-REFERENCE TO RELATED APPLICATIONS

This application claims priority under 35 USC § 119 (e) of U.S. Provisional Application No. 63/622,748 filed on Jan. 19, 2024, the specification of which is hereby incorporated by reference.

### FIELD

The present technology relates to the field of connectors, and more particularly to the field of connector assemblies for parts of manikins having a medical training application.

### BACKGROUND

In the field of patient simulators, some manikins are fully assembled in one product, and it is therefore difficult to remove and change parts. In this case, scenarios of simulation are restricted to manikin features with no exchanged parts. Furthermore, such manikins made of a single piece are cumbersome and heavy, rendering the storage of a manikin tedious for users.

Therefore, having manikins made of several removable parts can overcome the above-mentioned disadvantages. However, there is a need for connectors for removably assembling the different manikin parts together.

### SUMMARY

It is an object of the present technology to ameliorate at least some of the inconveniences present in the prior art. One or more implementations of the present technology may provide and/or broaden the scope of approaches to and/or methods of achieving the aims and objects of the present technology.

In accordance with a first broad aspect, there is provided a connector assembly comprising: a first connector comprising: a main body; a first hollow body having an inner face, the first hollow body being rotatably mounted to the main body and comprising at least one connection protrusion projecting inwardly from the inner face; and a biasing body mounted to the main body and the first hollow body for applying a biasing rotational force on the first hollow body in a first rotational direction; and a second connector comprising a second hollow body provided with at least one recess configured for receiving the at least one connection protrusion therein, the second hollow body comprising at least one engaging protrusion projecting within the at least one recess and comprising a sloping face, the sloping face defining a retaining slot within the at least one recess, wherein when the at least one connection protrusion is pushed against the sloping face of the at least one engaging protrusion, the first hollow body is rotated in a second rotational direction opposite to the first rotational direction until the at least one connection protrusion is positioned into the retaining slot, thereby removably securing the first and second connector together.

According to one embodiment, the first connector further comprises a first hybrid connector fixedly mounted to the main body, and the second connector further comprising a second hybrid connector fixedly mounted to the second hollow body and adapted to mate with the first hybrid connector, the first and second hybrid connectors being configured to operatively house therethrough at least one of: a plurality of electrical connector, a plurality of fluid connectors, and a plurality of optical connectors.

According to one embodiment, the biasing body of the first connector includes at least one of: a torsion spring, a coil spring, a gas spring and a magnetic spring.

According to one embodiment, the main body of the first connector further comprises a release trigger operatively connected to the first hollow body to enable said rotation of the first hollow body in the second rotational direction to removably secure the first and second connectors together.

According to one embodiment, the main body is cylindrical and defines a cavity to at least partially house the release trigger of the first connector, the release trigger being configured to translate transversely within the cavity of the main cylindrical body along the second rotational direction to enable said rotation of the first hollow body to removably secure the first and second connectors together.

According to one embodiment, the first connector further comprises a guiding body comprising: an annular plate to fixedly mount the main body and defining a central aperture; and a tubular wall projecting longitudinally from the annular plate around an inner circumference of the central aperture towards the main body, the tubular wall comprising at least one guiding groove extending longitudinally along the tubular wall from an inner face thereof to slidingly receive corresponding cross-sectionally shaped at least one rail of the second connector when the first and second connectors are secured together.

According to one embodiment, the second hollow body of the second connector is tubular, the at least one recess comprising two recesses radially opposed in the second hollow body to receive correspondingly positioned at least one connection protrusion of the first connector when the first and second connectors are secured together.

According to one embodiment, the second connector further comprises: at least one rail extending longitudinally along a given longitudinal length of the second hollow body and protruding radially therefrom to form a cross-sectional shape corresponding to at least one guiding groove of a guiding body of the first connector to slidingly mount said at least one guiding groove when the first and second connectors are secured together.

According to one embodiment, the first connector further comprises: a guiding body having an annular plate to fixedly mount the main body and defining a central aperture; and a tubular wall projecting longitudinally from the annular plate around an inner circumference of the central aperture towards the main body, the tubular wall comprising at least one guiding groove extending longitudinally along the tubular wall from an inner face thereof to slidingly receive corresponding cross-sectionally shaped at least one rail of the connection device when the first and second connectors are secured together; and wherein the second connector further comprises: at least one rail extending longitudinally along a given longitudinal length of the second hollow body and protruding radially therefrom.

In accordance with a second broad aspect, there is provided a connector comprising: a main body; a first hollow body having an inner face, the first hollow body being rotatably mounted to the main body and comprising at least one connection protrusion projecting inwardly from the inner face; and a biasing body mounted to the main body and the first hollow body for applying a biasing rotational force on the first hollow body in a first rotational direction, wherein the connector is removably connectable to a connection device comprising a second hollow body provided with at least one recess configured for receiving the at least one connection protrusion therein, the second hollow body comprising at least one engaging protrusion projecting within the at least one recess and comprising a sloping face, the sloping face defining a retaining slot within the at least one recess, and wherein when the at least one connection protrusion is pushed against the sloping face of the at least one engaging protrusion, the first hollow body is rotated in a second rotational direction opposite to the first rotational direction until the at least one connection protrusion is positioned into the retaining slot, thereby removably securing the connector and the connection device together.

According to one embodiment, the connector further comprises a hybrid connector fixedly mounted to the main body, the hybrid connector being configured to operatively house therethrough at least one of: a plurality of electrical connector, a plurality of fluid connectors, and a plurality of optical connectors.

According to one embodiment, the biasing body includes at least one of: a torsion spring, a coil spring, a gas spring, and a magnetic spring.

According to one embodiment, the main body further comprises a release trigger operatively connected to the first hollow body to enable said rotation of the first hollow body to removably secure the connector and the connection device together.

According to one embodiment, the main body is cylindrical and defines a cavity to at least partially house the release trigger, the release trigger being configured to translate transversely within the cavity of the main cylindrical body along the second rotational direction to enable said rotation of the first hollow body to removably secure the connector and the connection device together.

According to one embodiment, the connector further comprises further comprising a guiding body having an annular plate to fixedly mount the main body and defining a central aperture, and a tubular wall projecting longitudinally from the annular plate around an inner circumference of the central aperture towards the main body, and the tubular wall comprising at least one guiding groove extending longitudinally along the tubular wall from an inner face thereof to slidingly receive corresponding cross-sectionally shaped at least one rail of the connection device when the connector and the connection device are secured together.

In accordance with another broad aspect, there is provided a connector comprising: a first hollow body provided with at least one recess configured for receiving at least one connection protrusion of a connection device therein, the first hollow body comprising at least one engaging protrusion projecting within the at least one recess and comprising a sloping face, the sloping face defining a retaining slot within the at least one recess, wherein the connector is removably connectable to the connection device, the connection device comprising: a main body; a second hollow body having an inner face, the first hollow body being rotatably mounted to the main body and comprising the at least one connection protrusion projecting inwardly from the inner face; and a biasing body mounted to the main body and the first hollow body for applying a biasing rotational force on the first hollow body in a first rotational direction; and wherein when the at least one connection protrusion is pushed against the sloping face of the at least one engaging protrusion, the first hollow body is rotated in a second rotational direction opposite to the first rotational direction until the at least one connection protrusion is positioned into the retaining slot, thereby removably securing the connector and the connection device together.

According to one embodiment, the connector further comprises a hybrid connector fixedly mounted within the first hollow body, the hybrid connector being configured to operatively house therethrough at least one of: a plurality of electrical connector, a plurality of fluid connectors, and a plurality of optical connectors.

According to one embodiment, the sloping face is linearly bevelled.

According to one embodiment, the first hollow body is tubular, the at least one recess comprising two recesses radially opposed in the first hollow body to receive correspondingly positioned at least one connection protrusion of the connection device when the connector and the connection device are secured together.

According to one embodiment, the connector further comprises at least one rail extending longitudinally along a given longitudinal length of the first hollow body and protruding radially therefrom to form a cross-sectional shape corresponding to at least one guiding groove of a guiding body of the connection device to slidingly mount said at least one guiding groove when the connector and the connection device are secured together.

In the context of the present specification, the words “first,” “second,” “third,” etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspect, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a female connector or connector assembly comprising a torsion spring hidden behind an annular plate, in accordance with one or more non-limiting implementations of the present technology.

FIG. 2 is a top perspective view of a male connector or connector assembly removably connectable to the female connector assembly of FIG. 1, in accordance with one or more non-limiting implementations of the present technology.

FIG. 3 illustrates an exploded view of the female connector assembly of FIG. 1 and the male connector assembly with parts removed of FIG. 2.

FIG. 4 a front elevation view of a main cylindrical body contained in the female connector assembly of FIG. 1 with a trigger button, a hybrid connector, an annular plate, and a guiding body thereof removed.

FIG. 5 is a front elevation view of a rotation ring contained in the female connector assembly of FIG. 1, in accordance with one or more non-limiting implementations of the present technology.

FIG. 6 is a top perspective view of the main cylindrical body of FIG. 4 when the torsion spring and the rotation ring of FIG. 5 are inserted therein and the rotation ring is in a first or biased rotational position, in accordance with one or more non-limiting implementations of the present technology.

FIG. 7 is a top perspective view of the main cylindrical body of FIG. 4 when the torsion spring and the rotation ring of FIG. 5 are inserted therein and the rotation ring is in a second rotational position away from the first or biased position of FIG. 6, in accordance with one or more non-limiting implementations of the present technology.

FIG. 8 is a top perspective view of a first hybrid connector contained in the female connector assembly of FIG. 1, in accordance with one or more non-limiting implementations of the present technology.

FIG. 9 is a top perspective view of a second hybrid connector contained in the male connector assembly of FIG. 2 and connectable to the first hybrid connector of FIG. 8, in accordance with one or more non-limiting implementations of the present technology.

FIG. 10 depicts a further male connector or connector assembly, in accordance with one or more non-limiting implementations of the present technology.

FIG. 11 depicts a female connector or connector assembly comprising a compression spring and removably connectable to the male connector assembly of FIG. 10, in accordance with one or more non-limiting implementations of the present technology.

FIG. 12 illustrates an exploded view of the female connector assembly of FIG. 11, in accordance with one or more non-limiting implementations of the present technology.

FIG. 13 illustrates a partial view of a main tubular body, a trigger button and a rotation ring all contained in the female connector assembly, in accordance with one or more non-limiting implementations of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

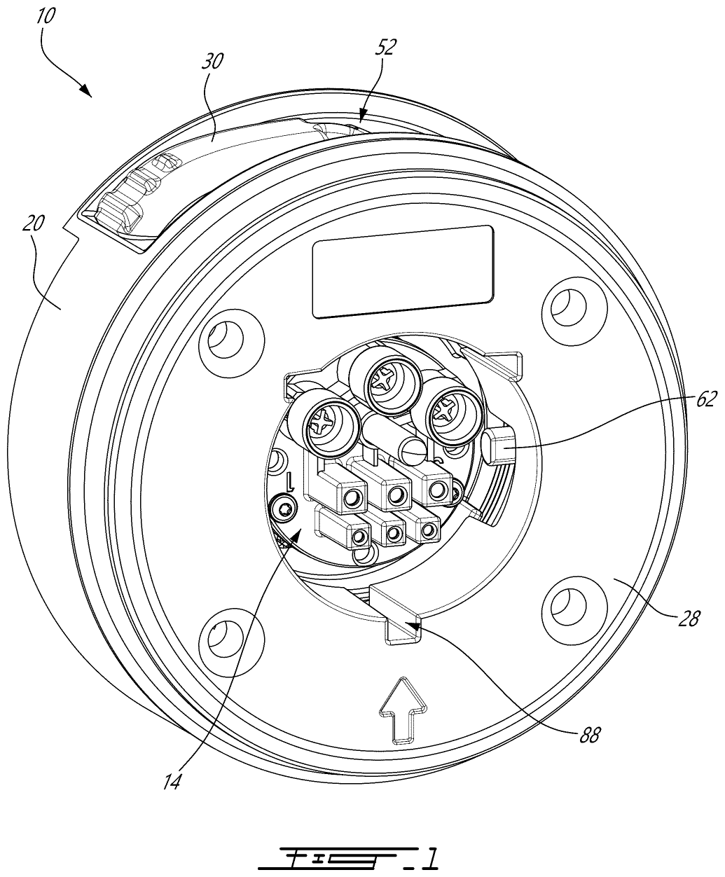

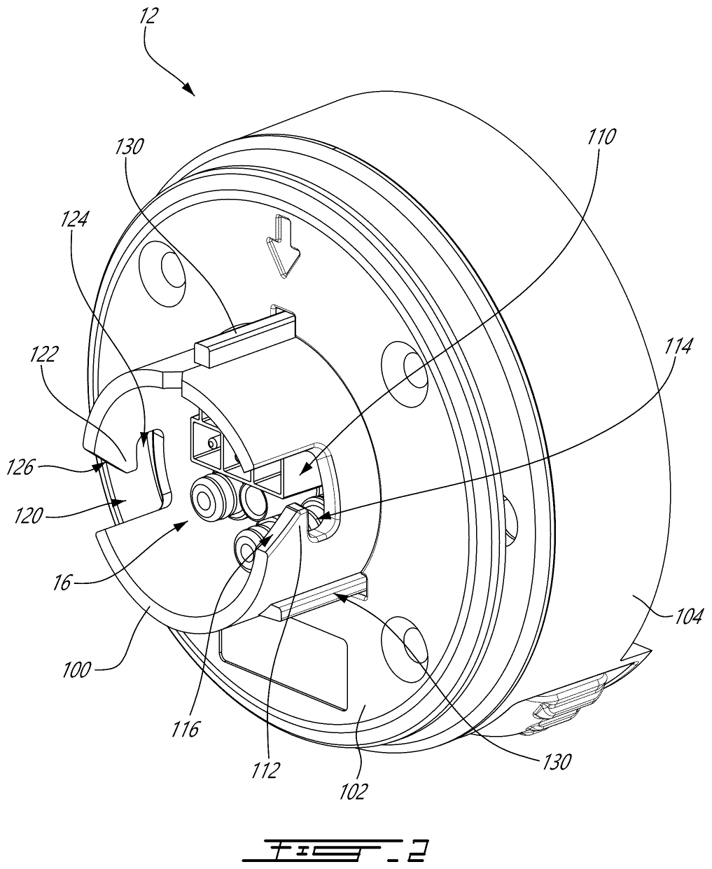

FIGS. 1 and 2 illustrate one embodiment of a connector assembly that comprises a female connector assembly 10 (FIG. 1) and a male connector assembly 12 (FIG. 2) configured to mate (i.e., shaped and sized to mate) the female connector assembly 10 so that the female and male connector assemblies 10 and 12 are removably securable together.

In the illustrated embodiment, the female connector assembly 10 comprises a first hybrid connector 14 and the male connector assembly 12 comprises a second hybrid connector 16 configured to mate the first hybrid connector 14 so that when the female and male connector assemblies 10 and 12 are connected together, the hybrid connectors 14 and 16 are also connected together. As described below in greater detail, the hybrid connectors 14 and 16 each comprise a plurality of electrical connectors and a plurality of fluid connectors. However, it should be understood that other configurations are possible. For example, each one of the female and male connector assemblies 10 and 12 may be provided with a respective electrical connector, a respective fluid connector, a respective optical connector, a respective secondary mechanical connector such as a drive shaft, etc. In a further example, the hybrid connectors 14 and 16 may not include an electrical connector, a fluid connector, an optical connector, and any other functional connectors. In this case, the female and male connector assemblies 10 and 12 correspond to mechanical connectors only, i.e., the female and male connector assemblies 10 and 12 do not provide any electrical, fluid or optical connection once they are connected together.

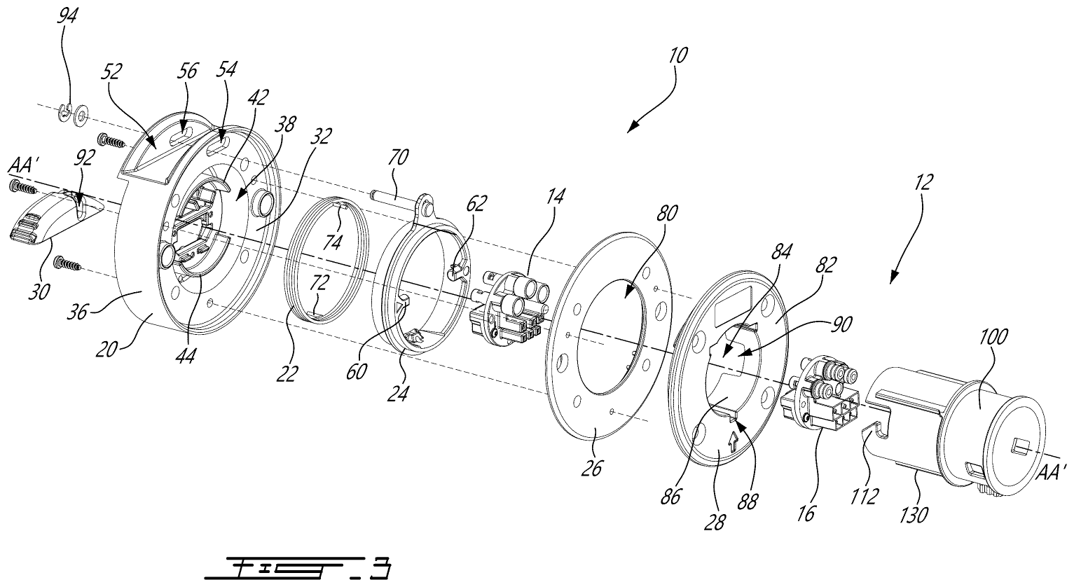

As illustrated in FIG. 3, the female connector assembly 10 comprises a main cylindrical body 20, a torsion spring 22, a rotation ring or annular body 24, a first annular plate 26, a guiding body 28 and a (release) trigger 30. The torsion spring 22 is fixedly secured to the main body 20 while the rotation ring 24 is rotatably mounted to the main body 20. The torsion spring 22 is mounted between the main body 20 and the rotation ring 24 so as to apply a biasing force or torque on the rotation ring 24, as described in greater detail below.

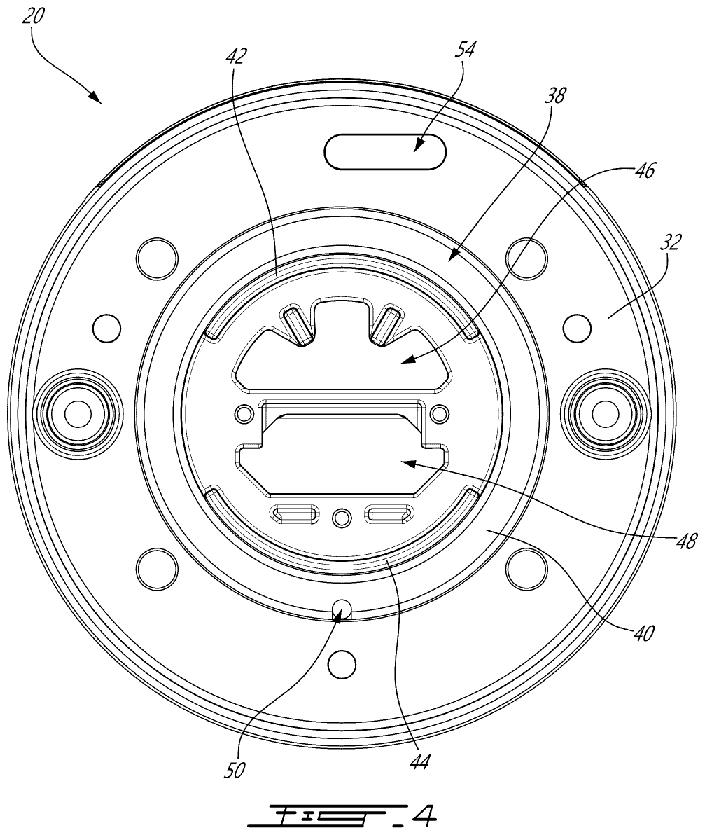

Referring to FIGS. 3 and 4, the main cylindrical body 20 extends longitudinally, along a longitudinal axis AA′, between a front face 32 and a rear face (not visible in FIGS. 3 and 4) which are connected together by a lateral wall 36. The main body 20 is provided with a cylindrical recess 38 extending inwardly from the front face 32 towards the rear face up to a support plate 40. Two hemispherical walls, or arced ribs 42 and 44 each project from the support plate 40 axially towards the front face 32 and face each other. As described below in greater detail, the two arced ribs 42 and 44 are shaped and positioned to support the torsion spring 22 and the rotation ring 24. Notably, an outer curvature of each one of the arced ribs 42 and 44 follows a curvature of a nearest portion of the surrounding wall defined between the support plate 40 and the front face 32. The support plate 40 is also provided with two apertures 46 and 48 for receiving the fluid and electrical connectors of the hybrid connector 14. Further, the support plate 40 is provided with a spring-receiving hole 50 for mounting the torsion spring 22 to the main body 20.

The main body 20 further comprises a cavity 52 extending transversely, i.e., normal to an axial direction along the longitudinal axis AA′, of the main body 20, through its lateral wall 36 and shaped and sized for receiving the trigger 30 therein and allowing a transversal translation of the trigger 30 therein. A first aperture or slot 54 extends axially through the front face 32 of the main body 20 and communicates with the cavity 52. A second aperture or slot 56 extends through the rear face of the main body 20 and also communicates with the cavity 52. In the illustrated embodiment, the first and second slots 54 and 56 are identical and face each other. More specifically, the first and second slots 54 and 56 are axially aligned. As described below, the first and second slots 54 and 56 are shaped and positioned to limit the rotation of the rotation ring 24.

It will be appreciated that the illustrated configuration of the trigger 30 that is housed within the lateral wall 36 contributes to the compactness of the female connector assembly 10 since the trigger does not substantially protrude beyond an outside periphery of the lateral wall 36 that defines the cylindrical shape of the main cylindrical body 20 (see FIG. 1).

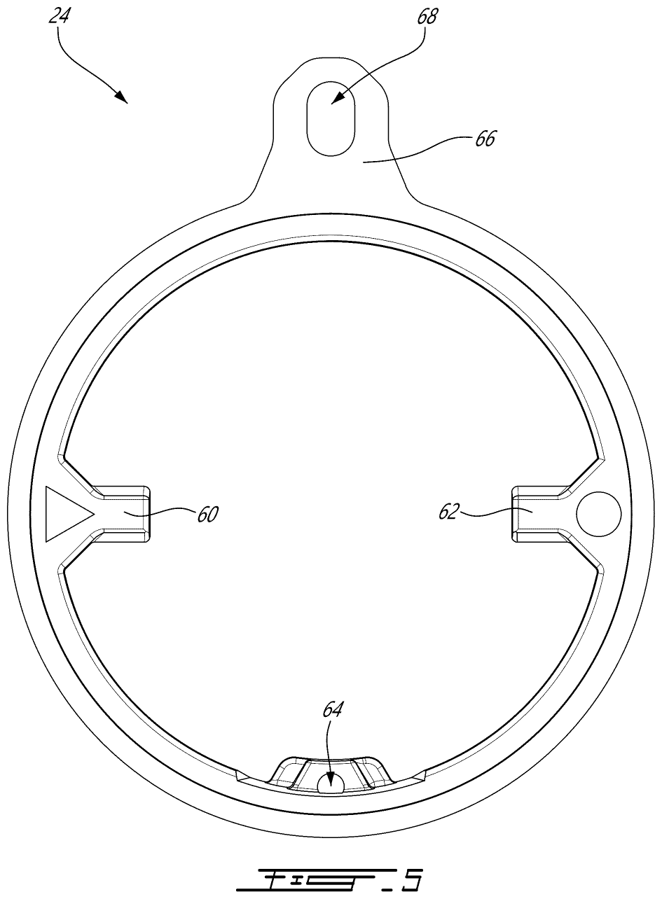

Referring to FIGS. 3 and 5, the rotation ring 24 is provided with two protrusions 60 and 62 which each project inwardly and concentrically from an inner face of the rotation ring 24. In the illustrated embodiment, the protrusions 60 and 62 are identical, face each other and are colinear. The rotation ring 24 is also provided with a first ring aperture 64 that extends through its thickness between its front and rear faces. The first ring aperture 64 is shaped to receive one end portion of the torsion spring 22, as described below. The rotation ring 24 is further provided with a tab 66 which projects radially and outwardly from an outer face of the rotation ring 24. A second ring aperture 68 extends through the tab 66. The second ring aperture 68 is shaped so as to receive therein a dowel 70.

Referring back to FIG. 3, the torsion spring 22 is provided with a first end portion 72 that projects outwardly from a first face of the torsion spring 22 in a first direction and a second end portion 74 which projects outwardly from a second face of the torsion spring 22 in a second direction opposite to the first direction. In the illustrated embodiment shown, the torsion spring 22 includes a resilient wire wound circularly about five times. However, the person skilled in the art will understand that other configurations are possible.

The first annular plate 26 comprises a central opening 80 shaped and sized for receiving therein at least the hybrid connector 14.

Still referring to FIG. 3, and regarding the female connector assembly 10, the guiding body 28 comprises a second annular plate 82 provided with a central aperture 84 and extending between a front face and a rear face. the guiding body 28 is further provided with a tubular wall 86 which projects longitudinally from a rear face of the second annular plate 82 and surrounds the central aperture 84 thereof. The tubular wall 86 is provided with a plurality of grooves or recesses 88 which each extend longitudinally along a length of the tubular wall 86. The grooves 88 are each located at a respective radial position along a circumference or an inner surface of the tubular wall 86. Each groove 88 also extends radially through a length of the second annular plate 82. The tubular wall 86 is further provided with two opposite recesses 90 each extending from a rear end of the tubular wall 86 towards a front end thereof. The recesses 90 are each shaped and positioned for allowing a rotation of the protrusions 60 and 62 of the rotation ring 24 within the first and second recesses 110 and 120 when the female connector assembly 10 is assembled together.

The trigger 30 comprises two lateral walls connected together by a top wall. The lateral walls are each provided with an aperture 92. The aperture 92 is positioned on its respective lateral wall. According to one embodiment, the aperture 92 may not fully extend through the two lateral walls to open on both walls and thus corresponds to a recess.

The person skilled in the art will understand that the first annular plate 26 is used for maintaining in position the torsion spring 22 and the rotation ring 24 within the recess 38 of the main body 20 when the female connector assembly 10 is assembled.

To assemble the female connector assembly 10, the torsion spring 22 is inserted around the arced ribs 42 and 44 while inserting the first end portion 72 of the torsion spring 22 into the spring-receiving hole 50 of the main body 20. Then the rotation ring 24 is also inserted around the arced ribs 42 and 44 while compressing the torsion spring 22 to allow the insertion of the second end portion 74 of the torsion spring 22 into the first ring aperture 64 of the rotation ring 24, thereby compressing the torsion spring 24 so that the torsion spring 24 exerts a biasing rotational force or torque in a first rotational direction, e.g., an anticlockwise direction from the perspective of FIG. 2, on the rotation ring 24 which is then in a biased rotational position. The trigger 30 is inserted into the cavity 52 of the main cylindrical body 20, and the dowel 70 is inserted into the second ring aperture 68 of the rotation ring 24, the first slot 54 of the main cylindrical body 20, the aperture 92 of the trigger 30 and the second slot 56 of the main cylindrical body 20. The dowel 70 is slidably secured in the first and second slots 54 and 56 using a nut 94 or any other suitable mechanical fastener. As a result of this assembly, a rotation of the rotation ring 24 triggers a motion of the dowel 70 within the first and second slots 54 and 56 and a translation of the trigger 30 within the cavity 52. Similarly, a translation of the trigger 30 within the cavity 52 triggers a motion of the dowel 70 within the slots 54 and 56 and a rotation of the rotation ring 24.

The hybrid connector 14 is mounted to the support plate 40 of the main body 20 while inserting the fluid connectors and the electrical connectors into their respective opening 46 and 48 (the openings 46 and 48 being better shown in FIG. 4). The first annular plate 26 is fixedly mounted or secured to the main body 20, thereby maintaining in position the torsion spring 22 and the rotation ring 24 into the recess 38 of the main body 20. The term “fixedly” or “fixedly” mounted as used herein means that an element is immobilized in a fixed state that may be reversible, and should not be restrictively construed to mean that an element is permanently fixed in position. Finally, the guiding body 28 is secured to the first annular plate 26 while inserting the tubular wall 86 into the opening 80 of the first annular plate 26. Once the guiding body 28 is securely mounted to the first annular plate 26, the protrusions 60 and 62 of the rotation ring 24 are positioned within a respective recess 90 of the tubular wall 86.

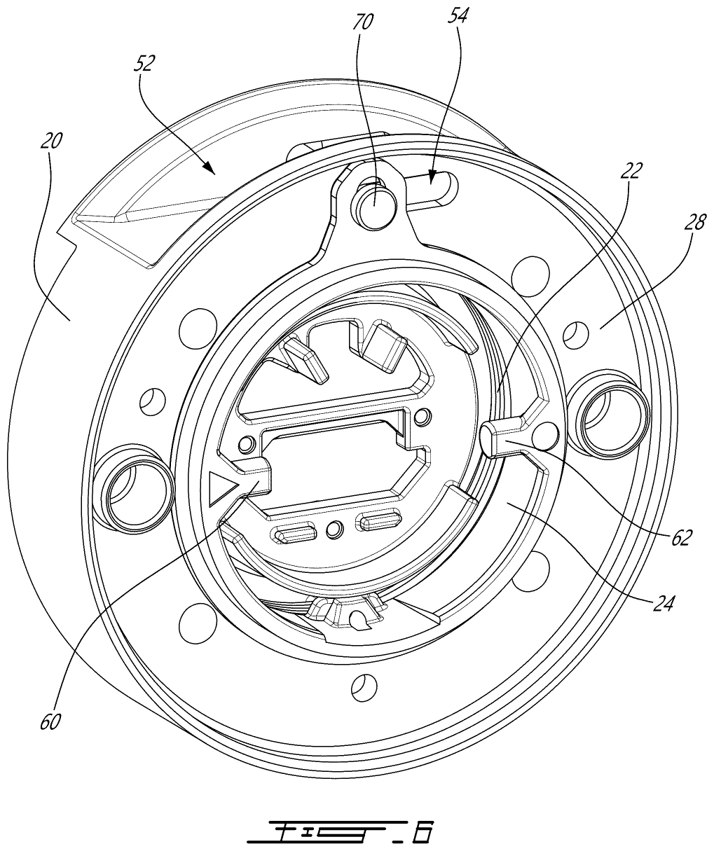

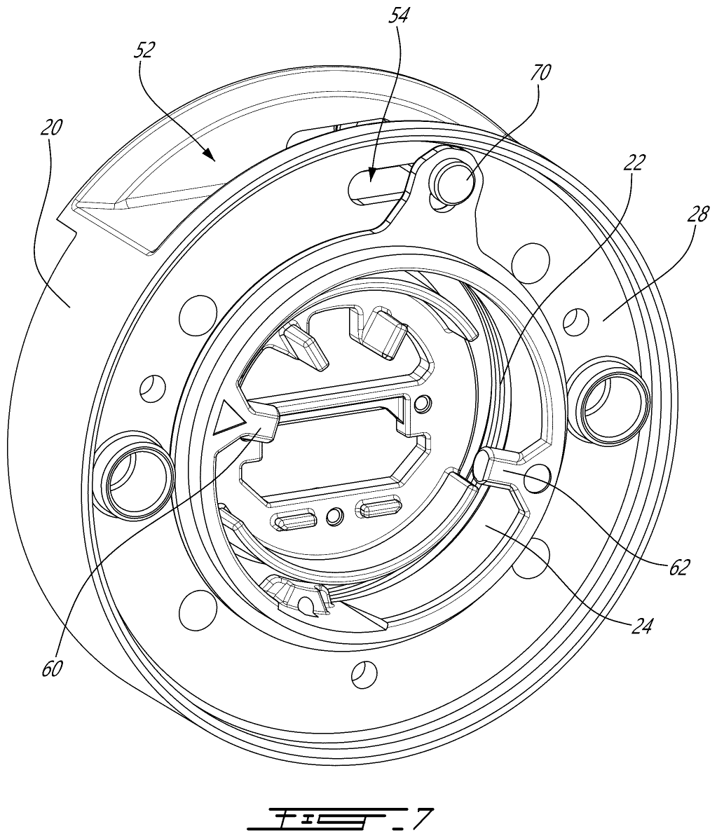

FIG. 6 illustrates the rotation ring 24 into a first extreme position, i.e., its biased position, while FIG. 7 illustrates the rotation ring 24 in a second extreme position obtained by rotating the rotation ring 24 in a second rotational direction, e.g., a clockwise direction from the perspective of FIGS. 1, 6 and 7. When the rotation ring 24 is in the first extreme position, the dowel 70 abuts against an extremity of each slots 54 and 56, and when the rotation ring 24 is in the second extreme position, the dowel 70 abuts against the other opposite end of the slots 54 and 56. As a result, the length of the slots 54 and 56 from one end to the other limits the possible rotation for the rotation ring 24.

Referring to FIGS. 2 and 3, the male connector assembly 12 comprises a tubular body 100, a third annular plate 102 and a main body 104, in addition to the hybrid connector 16. The hybrid connector 16 is mounted within the tubular body 100 and the third annular plate 102 is provided with a central opening for receiving therein a part of the tubular body 100. In the illustrated embodiment, the third annular plate 102 is rotatably mounted to the main body 104.

The tubular body 100 extends longitudinally between a front face connectable to the female connector assembly 10 and a rear face. A first recess 110 extends longitudinally from the front face towards the rear face of the tubular body 100 and a first hook-shaped protrusion or indentation 112 projects peripherally within the recess 110 to define a retaining slot 114. The first indentation 112 projects in the first rotational direction, i.e., the anticlockwise direction, and comprises a bevelled face 116 that extends from the front face of the tubular body 100. A second recess 120, circumferentially opposite to the first recess 110, extends longitudinally from the front face towards the rear face of the tubular body 100 and a second hook-shaped protrusion or indentation 122 projects peripherally within the second recess 120 to define a retaining slot 124. The second indentation 122 projects in the first rotational direction, i.e., the anticlockwise direction, and comprises a bevelled face 126 that extends from the front face of the tubular body 100. The first and second recesses 110 and 120 are located at radially opposite positions so as to face each other.

It should be understood that the expression “hook-shaped protrusion” refers to a protrusion of which the height varies therealong to form a sloping face. In the illustrated implementation, the height of the first and second indentations 112 and 122 varies continuously as to form the beveled face 116, 126. However, the height of the indentations 112 and 122 may vary non-continuously so as to form a rounded sloping face for example.

The tubular body 110 further comprises longitudinal protrusions or rails 130 that each extend longitudinally along a given length of the tubular body 110 adjacent to the front face thereof. The radial position around the tubular body 110 and the shape and size of the rails 130 is chosen based on the corresponding radial positions around the tubular wall 86 and the shape and size of the grooves 88 of the guiding body 28, so that when the tubular body 100 is inserted into the female connector assembly 10 each rail 130 can be received in a respective groove 88. As a result, the grooves 88 and the rails 130 form a guiding structure to adequately insert the tubular body 110 into the female connector assembly 10 so that the fluid connectors and the electrical connectors of the second hybrid connector 16 connect to their respective fluid connectors and the electrical connectors of the first hybrid connector 14. Further, a male connector assembly of which the number, radial position, shape and/or size of the rails do not match these of the female connector assembly cannot be secured-or at least not properly secured-to the female connector assembly, thereby ensuring that only an allowed or adequate male connector assembly can be secured to the female connector assembly. In other words, the guiding body 28 forms and acts as a captivity system. It should be understood that the grooves 88 of the female connector assembly 10 may be identical and, in this case, the rails 130 may also be identical as long as each rail 130 may be received in a respective groove 88. Alternatively, at least some of the grooves 88 may have different shape and/or size. In this case, the at least some of the rails 130 also have different shape and/or size as long as each rail 130 may be received in a respective groove 88. For instance, the rails can have a cross-section profile (i.e., a cross-sectional shape) and dimensions that differs from the square and triangle shape rails 130 cross-sections being shown. In one embodiment (not shown), the cross-section profile of the rails can have the same shape as shown, but extend further outwardly and radially. In another embodiment, the rails 130 have a cross-section profile having a star-shape, a circle shape, a C-shape, etc.

In order to connect the female and male connector assemblies 10 and 12, the front face of the tubular body 100 of the male connector assembly 12 is inserted through the central aperture 84 of the second annular plate 82 and the central opening 80 of the first annular plate 26 while each rail 130 is inserted in a respective groove 88 of the guiding body 28. The tubular body 100 is inserted into the female connector assembly 10 until the beveled face 116 of the first indentation 112 and the beveled face 126 of the second indentation 122 abut against the protrusions 60 and 62, respectively. By further pushing on the tubular body 100 in the axial direction, the beveled faces 116 and 126 exert a force of the protrusions 60 and 62. When the exerted force by the beveled faces 116 and 126 is greater than the biasing force exerted by the torsion spring 22 on the rotation ring 24, the rotation ring 22 rotates in the second rotational direction, i.e., the clockwise direction, away from its biased position while further compressing the torsion spring 22, and the protrusions 60 and 62 slide along their respective beveled face 116, 126 until the protrusions 60 and 62 are each received in their respective retaining slot 114, 124. When the protrusions 60 and 62 of the rotation ring 24 are received in the retaining slots 114 and 124 of the tubular body 100, respectively, the biased rotational force exerted by the torsion spring 22 on the rotation ring 24 prevents the protrusions 60 and 62 from moving away from their respective retaining slot 114, 124 and the male connector assembly 12 is removably secured to the female connector assembly 10.

In order to disengage the female and male connector assemblies 10 and 12, a force is exerted on the trigger 30 (e.g., an external force exerted by a user of the male and female connector assemblies 10 and 12) to trigger a translation of the trigger 30 within the cavity 52, which in turn triggers a translation of the dowel 70 along the slots 54 and 56 and the translation of the dowel 70 triggers a rotation of the rotation ring 24 in the second rotational direction, i.e., the clockwise direction, and a compression of the torsion spring 22. As a result, the protrusions 60 and 62 of the rotation ring 24 of the female connector assembly 10 move away from their respective retaining slots 114, 124 and they can be removed from the recess 110, 120 by pulling on the male connector assembly 12 longitudinally, thereby disconnecting the female and male connector assemblies 10 and 12.

It should be understood that while the female and male connector assemblies 10 and 12 are connected as described above, the hybrid connectors 14 and 16 are also connected together.

It should be understood that the above-described female and male connector assemblies 10 and 12 may be modified without departing from the scope of this disclosure or rendering the assemblies 10 and 12 dysfunctional. For example, the trigger 30, the slots 54 and 56, the dowel 70, and the tab 66 of the female connector assembly 10 may be omitted. In this case, the female and male connector assemblies 10 and 12 may be disconnected by manually rotating the male connector assembly 12 in an anticlockwise direction to compress the torsion spring 22 and disengage the protrusions 60 and 62 from their retaining slots 114 and 124.

It should be understood that any adequate means for rotatably securing the rotation ring 22 to the main body 20 may be used and any adequate means for securing the torsion spring to the main body 20 and the rotation ring 24 may also be used. For example, the recess 38 may be omitted and the arced ribs 42 and 44 may protrude from the front face of the main body 20. It will be appreciated that having a recess 38 in the main body 20 at least partially contributes to a relatively compact female connector assembly 10.

In some implementations, the grooves 88 of the guiding body and the rails 130 or the tubular body 100 may be omitted.

It should be understood that the number of protrusions 60, 62 of the rotation ring 24 and therefore the number of recesses 110, 120 may vary as long as the rotation ring 22 comprises at least one protrusion 60, 62 and the tubular body 100 comprises at least one recess 110, 120. It should also be understood that the shape and position of the protrusions 60 and 62, and the shape and position of the recesses 110 and 120 may vary as long as the protrusion 60, 62 is insertable and retainable into the recess 110, 120. For example, the beveled face 116, 126 could be replaced with a rounded face. As another example of the shape of the first and second recesses 110, 120 of the tubular body 100 varying from what is being shown, instead of extending longitudinally and substantially linearly from the front face towards the rear face of the tubular body 100, each one of the recesses 110, 120 may extend from the front face to the rear face following a curvilinear shape arcing in the second rotational direction, i.e., the clockwise direction. It is understood that the rotational movement range of the annular ring 24 in such embodiment would be adjustably increased (see FIGS. 6 and 7). The first and second indentations 112, 122 may still be present in the curvilinear recesses to define retaining slots 114, 124, respectively, in the first rotational direction as previously explained.

It should also be understood that the biasing mechanism, i.e., the mechanism that exerts a rotational biasing force on the rotation ring 24, may vary and that the female connector assembly may comprise any adequate biasing or resilient member or element configured for applying a biasing force on the rotation ring 24 as described above. For example, in alternative embodiments, the biasing body can include a coil spring, a gas spring, an elastomeric spring, and a magnetic spring, provided that the required adjustments are made to the connector assembly.

While the torsion spring 24 is removably mounted to the main body 20 and the rotation ring 24 by inserting its end portions 72 and 74 into the first and second ring apertures 50 and 64, it should be understood that any other adequate method of removably or permanently securing the torsion spring 24 to the main body 20 and the rotation ring 24 may be used. For example, the end portions 72 and 74 of the torsion spring 24 may be welded, glued or otherwise fastened to the main body 20 and the rotation ring 24.

It should further be understood that the shape and/or size of some elements of the female and male connector assemblies 10 and 12 may vary. For example, the tubular body 100 may be replaced with a hollow body having a rectangular, square, triangular, or oval cross-sectional shape, as long as the recesses 110 and 120 are present. In another example, the recess 38 of the main body 20 may have a rectangular, square, triangular, or oval shape as long as the torsion spring 22 can be inserted therein and the rotation ring 24 can be inserted and rotate therein.

In some implementations, the female and male connector assemblies 10 and 12 allow for a quick and easy connection and disconnection.

In some implementations, the female and male connector assemblies 10 and 12 allow for an easy replacement of the hybrid connectors 14 and 16 while not replacing the connector assemblies 10 and 12.

In some implementations, the female and male connector assemblies 10 and 12 are used in the context of a manikin for connecting limbs and/or a head to a torso of the manikin. For example, the manikin may comprise four male connector assemblies secured to the torso each a position representing an arm or a leg. Each arm and each leg may be provided with a respective female connector assembly for removably securing the arm or leg to the torso. The female and male connector assemblies 10, when provided with a hybrid connector 14 or 16, then allow an exchange of fluid and/or electrical signals between the torso and the legs and arms.

As previously explained regarding the captivity system, the pattern of the rails of each male connector assembly mounted to the torso may be unique. In this case, the female connector assembly of each leg/arm is provided with a unique pattern of grooves that mates with the pattern of rails of its respective male connector assembly on the torso so that only the right arm may be only connected to the male connector assembly mounted at the position of the right arm on the torso, the left arm may be only connected to the male connector assembly mounted at the position of the left arm on the torso, etc.

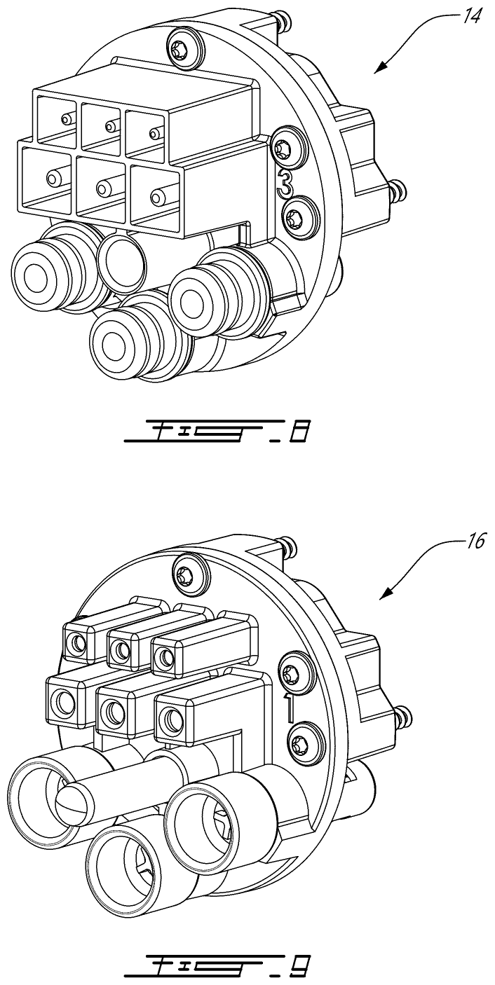

FIG. 8 illustrates one embodiment of the hybrid connector 14 which comprises three 22-gauge pins male connectors, three 20-gauge pins male connectors and three female fluid connectors. The hybrid connector 14 is further provided with an alignment pin.

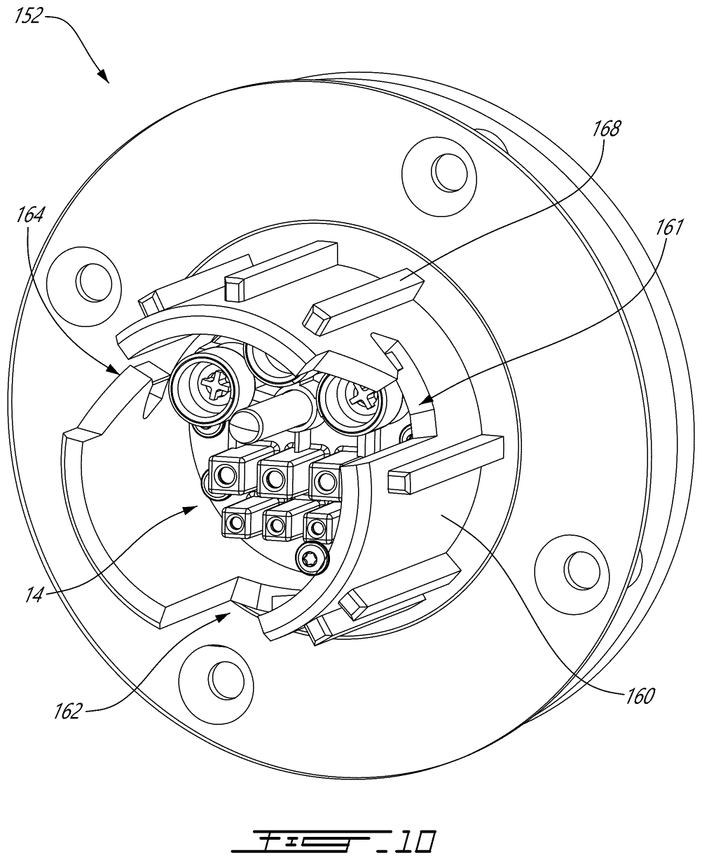

FIG. 9 illustrates one embodiment of a hybrid connector 16 which comprises three 22-gauge pins female connectors, three 20-gauge pins female connectors and three male fluid connectors. The hybrid connector 16 is further provided with an alignment recess or aperture for receiving therein the alignment pin of the hybrid connector 14.

In the following there is described alternative embodiments for the female and male connector assemblies 10 and 12, i.e., a female connector assembly 150 and a male connector assembly 152 which are removably connectable together.

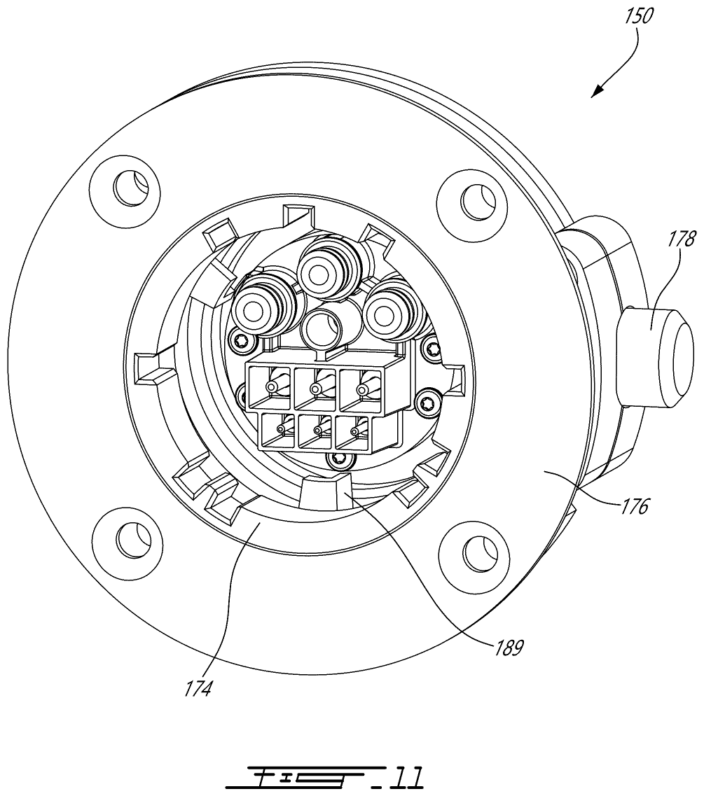

Referring to FIG. 10, there is illustrated the male connector assembly 152. The male connector assembly 152 would be similar to the male connector assembly of FIGS. 2 and 3, and therefore only the differences between the assemblies are described herein for the purpose of conciseness. The alternative male connector assembly 152 comprises a tubular body 160 provided with three recesses 161, 162 and 164 each extending from a front face thereof and located at a respective radial position about the tubular body 160. The shape of the recesses 161, 162 and 164 is similar to that of the recesses 110 and 120 of FIGS. 2 and 3. The tubular body 160 is also provided with rails or protrusions 168 which may be similar to the rails previously described 130.

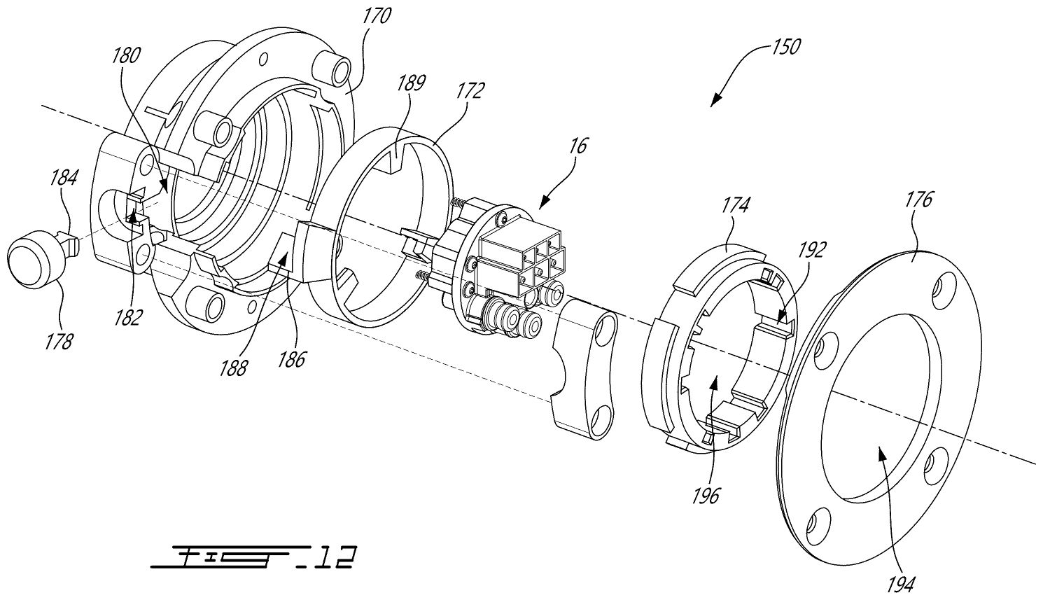

Referring to FIGS. 11, 12 and 13, there is described the female connector assembly 150. While the female connector assembly 10 of FIGS. 1, and 3 to 7 comprises a torsion spring for exerting a rotation force on a rotation ring, the female connector assembly 150 comprises a compression spring for exerting the rotational force on a rotation ring as described below.

The female connector assembly 150 comprises a main tubular body 170, a compression spring (not shown), a rotation ring 172, a guiding annular plate 174, an annular plate 176 and a trigger button 178. The main tubular body 170 has a varying internal diameter for rotatably receiving the rotation ring 172 therein. As a result, the rotation plate 172 is rotatably mounted into the tubular body 170.

The tubular body 170 of the female connector assembly 150 is provided with a recess 180 that extends from the front face thereof, and an opening 182 adjacent to the recess 180. The trigger button 178 extends through the opening 182 so that a head 184 of the trigger button 178 is located within the opening defined by the tubular body 170.

The rotation ring 172 is provided with a protrusion 186 that projects outwardly from the outer face of the rotation ring 172. The protrusion 186 comprises a rear face 187 and a beveled face 188 that extends between the outer face of the rotation ring 172 and the rear face 187 along a given length of the outer circumference of the rotation ring 172. The rotation ring 172 is inserted into the tubular body 170 so that the head 184 of the trigger button 178 abuts against the beveled face of the protrusion 186 of the rotation ring 172, as illustrated in FIG. 13. The tubular body 170 further comprises a spring-receiving groove 190 on its internal face for receiving therein the compression spring. The groove 190 extends along a given section of the circumference of the inner face of the tubular body. The groove 190 is shaped and positioned so that the compression spring may be inserted therein and when the compression spring is inserted into the groove 190, one longitudinal end of the compression spring abuts against the rear face 187 of the protrusion 186 so as to exert a rotational force on the protrusion 186 and therefore on the rotation ring 172. The beveled face 188 of the protrusion 186 then exerts a force on the head 184 of the trigger button 178 which prevents any rotation of the rotation ring 172. The rotation ring 172 is then biased into a first or biased radial position.

The rotation ring 172 is further provided with three inner protrusions each projecting inwardly from the inner face of the rotation ring 172. Each protrusion 189 is located at a respective radial position along the circumference of the inner face of the rotation ring 172. The radial position, shape and size of each protrusion 189 is chosen so as to engage with a respective recess 161, 162, 164 of the tubular body 160 of the male connector assembly 152.

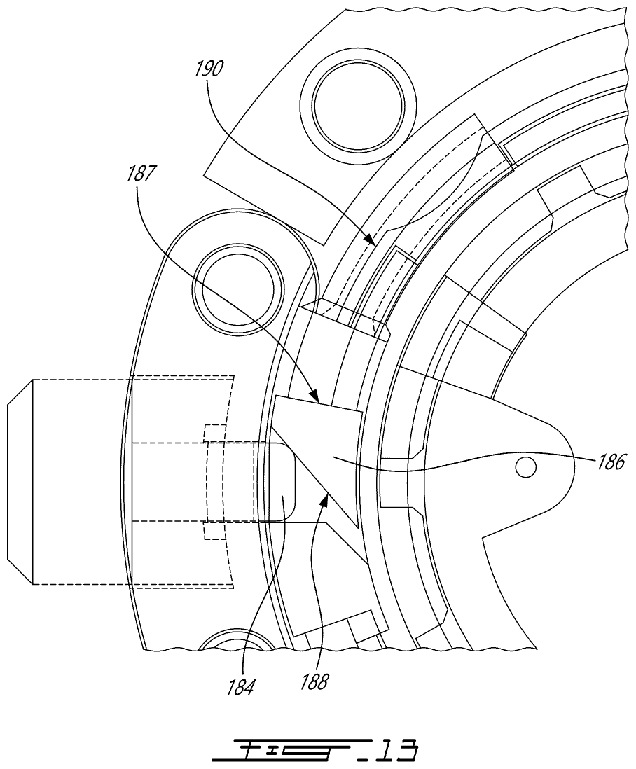

Referring back to FIG. 12, the guiding annular plate of the female connector assembly 150 is provided with a plurality of grooves or recesses 192 which each extend longitudinally along the length of the guiding annular plate 174 on the inner face thereof. The grooves 192 are each located at a respective radial position along the inner circumference of the guiding annular plate 174. Each groove 192 is shaped, sized and radially positioned so as to receive therein a respective rail 168 of the tubular body 170. The guiding plate 174 is fixedly inserted into the opening defined by the tubular body so that the guiding plate 174 may not rotate within the tubular body 170.

The annular plate 176 is provided with an opening for receiving therein the tubular body 160 of the male connector assembly 152. The annular plate is secured to the tubular body 170 to keep in position the rotation ring 172 and the guiding plate 174 within the tubular body 170.

In order to connect the alternative female and male connector assemblies 150 and 152, the front face of the tubular body 160 of the male connector assembly 152 is inserted through the aperture 194 of the annular plate 176 and the aperture 196 of the guiding plate 174 while each rail 168 is inserted a respective groove 192. The tubular body 160 is inserted into the female connector assembly 150 until the beveled face of the protrusions extending within the recesses 161, 162 and 164 each abut against a respective protrusion 189 of the rotation ring 172. By further pushing on the tubular body 160, the beveled faces 116 and 126 exert a force on the protrusions 60 and 62. When the exerted force by the beveled face of the protrusions 161, 162 and 164 extending within the recesses becomes greater than the biasing force exerted by the compression spring on the rotation ring 172, the rotation ring 172 rotates in an anticlockwise direction away from its biased position while further compressing the compression spring, and each protrusion 189 slides along their respective beveled face on the tubular body 160 until they are each received in their respective retaining slot within the recesses 161, 162 and 164. When the protrusions 189 are received in their respective retaining slots, the rotational force exerted by the compression spring on the rotation ring 172 in the clockwise direction prevents the protrusions 189 from moving away from their respective retaining slot and the male connector assembly 152 is removably secured to the female connector assembly 150.

In order to disengage the female and male connector assemblies 150 and 152, the trigger button 178 is pushed so that the head 184 of the trigger button 178 exerts a force on the beveled face 188 of the protrusion 186, which results in a rotation of the rotation ring 172 in an anticlockwise direction and a compression of the compression ring. As a result of the rotation of the rotation ring 172, the protrusions 189 move away from their retaining slot and they can be removed from the recesses 161, 162 and 164 by pulling on the male connector assembly 152, thereby disconnecting the female and male connector assemblies 150 and 152.

It should be expressly understood that not all technical effects/features mentioned herein need to be enjoyed in each and every implementation of the present technology. For example, implementations of the present technology may be implemented without the user enjoying some of these technical effects/features, while other non-limiting implementations may be implemented with the user enjoying other technical effects/features or none at all.

Modifications and improvements to the above-described implementations of the present technology may become apparent to those skilled in the art. The foregoing description is intended to be exemplary rather than limiting.

What is claimed is:

1. A connector assembly comprising:
a first connector comprising:
a main body;
a first hollow body having an inner face, the first hollow body being rotatably mounted to the main body and comprising at least one connection protrusion projecting inwardly from the inner face; and
a biasing body mounted to the main body and the first hollow body for applying a biasing rotational force on the first hollow body in a first rotational direction; and
a second connector comprising:
a second hollow body provided with at least one recess configured for receiving the at least one connection protrusion of the first connector therein, the second hollow body comprising at least one engaging protrusion projecting within the at least one recess and comprising a sloping face, the sloping face defining a retaining slot within the at least one recess,
wherein when the at least one connection protrusion is pushed against the sloping face of the at least one engaging protrusion, the first hollow body of the first connector is rotated in a second rotational direction opposite to the first rotational direction until the at least one connection protrusion is positioned into the retaining slot, thereby removably securing the first and second connector together.

2. The connector assembly of claim 1, wherein the first connector further comprises a first hybrid connector fixedly mounted to the main body, and the second connector further comprising a second hybrid connector fixedly mounted to the second hollow body and adapted to mate with the first hybrid connector, the first and second hybrid connectors being configured to operatively house therethrough at least one of: a plurality of electrical connector, a plurality of fluid connectors, and a plurality of optical connectors.

3. The connector assembly of claim 1, wherein the biasing body of the first connector includes at least one of: a torsion spring, a coil spring, a gas spring and a magnetic spring.

4. The connector assembly of claim 1, wherein the main body of the first connector further comprises a release trigger operatively connected to the first hollow body to enable said rotation of the first hollow body in the second rotational direction to removably secure the first and second connectors together.

5. The connector assembly of claim 4, wherein the main body is cylindrical and defines a cavity to at least partially house the release trigger of the first connector, the release trigger being configured to translate transversely within the cavity of the main cylindrical body along the second rotational direction to enable said rotation of the first hollow body to removably secure the first and second connectors together.

6. The connector assembly of claim 1, wherein the first connector further comprises a guiding body comprising:
an annular plate to fixedly mount the main body and defining a central aperture; and
a tubular wall projecting longitudinally from the annular plate around an inner circumference of the central aperture towards the main body,
the tubular wall comprising at least one guiding groove extending longitudinally along the tubular wall from an inner face thereof to slidingly receive corresponding cross-sectionally shaped at least one rail of the second connector when the first and second connectors are secured together.

7. The connector assembly of claim 1, wherein the second hollow body of the second connector is tubular, the at least one recess comprising two recesses radially opposed in the second hollow body to receive correspondingly positioned at least one connection protrusion of the first connector when the first and second connectors are secured together.

8. The connector assembly of claim 1, wherein the second connector further comprises:
at least one rail extending longitudinally along a given longitudinal length of the second hollow body and protruding radially therefrom to form a cross-sectional shape corresponding to at least one guiding groove of a guiding body of the first connector to slidingly mount said at least one guiding groove when the first and second connectors are secured together.

9. The connector assembly of claim 1, wherein the first connector further comprises:
a guiding body having an annular plate to fixedly mount the main body and defining a central aperture; and
a tubular wall projecting longitudinally from the annular plate around an inner circumference of the central aperture towards the main body,
the tubular wall comprising at least one guiding groove extending longitudinally along the tubular wall from an inner face thereof to slidingly receive corresponding cross-sectionally shaped at least one rail of the connection device when the first and second connectors are secured together; and
wherein the second connector further comprises:
at least one rail extending longitudinally along a given longitudinal length of the second hollow body and protruding radially therefrom.

10. A connector comprising:
a main body;
a first hollow body having an inner face, the first hollow body being rotatably mounted to the main body and comprising at least one connection protrusion projecting inwardly from the inner face; and
a biasing body mounted to the main body and the first hollow body for applying a biasing rotational force on the first hollow body in a first rotational direction,
wherein the connector is removably connectable to a connection device comprising a second hollow body provided with at least one recess configured for receiving the at least one connection protrusion therein, the second hollow body comprising at least one engaging protrusion projecting within the at least one recess and comprising a sloping face, the sloping face defining a retaining slot within the at least one recess, and
wherein when the at least one connection protrusion is pushed against the sloping face of the at least one engaging protrusion, the first hollow body is rotated in a second rotational direction opposite to the first rotational direction until the at least one connection protrusion is positioned into the retaining slot, thereby removably securing the connector and the connection device together.

11. The connector of claim 10, further comprising a hybrid connector fixedly mounted to the main body, the hybrid connector being configured to operatively house therethrough at least one of: a plurality of electrical connector, a plurality of fluid connectors, and a plurality of optical connectors.

12. The connector of claim 10, wherein the biasing body includes at least one of: a torsion spring, a coil spring, a gas spring, and a magnetic spring.

13. The connector of claim 10, wherein the main body further comprises a release trigger operatively connected to the first hollow body to enable said rotation of the first hollow body to removably secure the connector and the connection device together.

14. The connector of claim 13, wherein the main body is cylindrical and defines a cavity to at least partially house the release trigger, the release trigger being configured to translate transversely within the cavity of the main cylindrical body along the second rotational direction to enable said rotation of the first hollow body to removably secure the connector and the connection device together.

15. The connector of claim 10, further comprising a guiding body having an annular plate to fixedly mount the main body and defining a central aperture, and a tubular wall projecting longitudinally from the annular plate around an inner circumference of the central aperture towards the main body, and the tubular wall comprising at least one guiding groove extending longitudinally along the tubular wall from an inner face thereof to slidingly receive corresponding cross-sectionally shaped at least one rail of the connection device when the connector and the connection device are secured together.

16. A connector comprising:
a first hollow body provided with at least one recess configured for receiving at least one connection protrusion of a connection device therein, the first hollow body comprising at least one engaging protrusion projecting within the at least one recess and comprising a sloping face, the sloping face defining a retaining slot within the at least one recess,
wherein the connector is removably connectable to the connection device, the connection device comprising:
a main body;
a second hollow body having an inner face, the first hollow body being rotatably mounted to the main body and comprising the at least one connection protrusion projecting inwardly from the inner face; and
a biasing body mounted to the main body and the first hollow body for applying a biasing rotational force on the first hollow body in a first rotational direction,
wherein when the at least one connection protrusion is pushed against the sloping face of the at least one engaging protrusion, the first hollow body is rotated in a second rotational direction opposite to the first rotational direction until the at least one connection protrusion is positioned into the retaining slot, thereby removably securing the connector and the 20 connection device together.

17. The connector of claim 16, further comprising a hybrid connector fixedly mounted within the first hollow body, the hybrid connector being configured to operatively house therethrough at least one of: a plurality of electrical connector, a plurality of fluid connectors, and a plurality of optical connectors.

18. The connector of claim 16, wherein the sloping face is linearly bevelled.

19. The connector of claim 16, wherein the first hollow body is tubular, the at least one recess comprising two recesses radially opposed in the first hollow body to receive correspondingly positioned at least one connection protrusion of the connection device when the connector and the connection device are secured together.

20. The connector of claim 16, further comprising at least one rail extending longitudinally along a given longitudinal length of the first hollow body and protruding radially therefrom to form a cross-sectional shape corresponding to at least one guiding groove of a guiding body of the connection device to slidingly mount said at least one guiding groove when the connector and the connection device are secured together.
